(19) United States
(12) Patent Application Publication
(10) Pub. No.: US 2007/0193378 A1
(43) Pub. Date: Aug. 23, 2007

(54) Powder monitor

(75) Inventors: Urs Feuz, Weiningen (CH); Thomas Bisig, Wetzikon (CH)

Correspondence Address: MCCORMICK, PAULDING & HUBER LLP, CITY PLACE II, 185 ASYLUM STREET, HARTFORD, CT, 06103, US

(73) Assignee: ELPATRONIC AG

(21) Appl. No.: 10/571,881

(22) PCT Filed: Sep. 16, 2004
(86) PCT No.: PCT/CH04/00586

§ 371 Date: Dec. 11, 2006

(30) Foreign Application Priority Data
Sep. 16, 2003 (CH) 1582/03

(51) Int. Cl. B23Q 17/00; G01M 19/00

(52) U.S. Cl. 73/865.8; 29/407.01; 118/712

(57) ABSTRACT

The inventive sensor illuminates the powder layer (40) by means of sensing segments (30, 31, 32), said powder layer scattering the measuring beams. Flaws in the powder layer lead to increased reflection such that a reflected measuring beam is reflected into the segments (30, 31, 31). The reflected beams are guided to a control unit (21) by the fiber lines. Said control unit recognizes flaws according to fluctuations in the intensity of reflected beams and generates a corresponding control signal.

The invention concerns a method and an apparatus for the measurement of the layer thickness of the powder coating on a work piece according to claims 1 and 11.

Metal surfaces are often protected by a coating if the metal or alloy itself does not have sufficient corrosion resistance. Countless applications are known to persons skilled in the art in a case where, for example, overlaying powder is sprayed on to work piece surfaces and is hardened by a subsequent heat treatment. The quality of the applied protective layer is determined by the uniformity of the layer thickness or by fault spots in the coating.

Instead of powder, liquid lacquer coatings are also conceivable, and furthermore metal layers can also be provided.

For example, sheets with a protective tin layer are known as white sheets and are among other things used for the production of three part cans.

The bodies of sheet metal packages, especially of three part cans, are predominantly made with the help of resistance welding. In the welding process, the tin layer is removed at the place of the welding seam, so that then unprotected sheet metal lies at this place. In a subsequent processing step therefore, the raw seam is again covered with a protective layer. This is achieved either by liquid lacquer or by the spraying on of a powder layer which is brought into liquid condition in a following oven and which after cooling hardens into a protective layer having the desired characteristics. The covering of the welding seam of can bodies by means of such a powder lacquer takes place above all on the inner side of cans and is being increasingly used. Today, achievable welding speeds lie at 100 m/min and more, which leads to a corresponding requirement for suitable equipment for the powder seam coating.

The amount of powder used in the seam coating presents a relevant cost factor in the can production. Accordingly, it is attempted to keep the layer thickness as thin as possible, but it can nevertheless not be too thin reliably avoid corrosion of the welding seam, especially in the case of aggressive can contents, particularly if a month or year long storage of the filled cans is contemplated.

A fault containing coating of the welding seam can lead not only to a contamination of the can contents, but also can lead to a leakage with the escaping can contents contaminating the environment.

Until the present time, it has not been possible to maintain a coating thickness within a very narrow tolerance region under production conditions:

First of all the powder/air mixture which is sprayed onto the welding seam has to be transported several meters through thin and bent conductors to the spraying station which because of the long transport and with reference to the individual cans can lead to the result of a nonuniform powder coating. Also the behavior of the powder is influenced by the powder grains having unavoidable different grain diameters. Finally, in respect to its adhesion to the can sheet metal, the powder has to be electrostatically charged. The powder coating is further influenced by the production conditions of the environment such as temperature and humidity and by the changing properties of the recycled powder.

This problem has been known for a long time and has lead to the fact that calibration of the powder seam coating equipment for a production run to be undertaken is made using basic values and that the fine calibration is then achieved using test runs.

Even in the case of such calibration of production equipment for trouble free operation, there arrives after a certain production time a shifting of operating parameters (humidity, change in the recycled powders, as above mentioned). The equipment must then be re-adjusted, which involves a production stoppage and further test runs.

Known methods for monitoring the applied powder mass continuously detect the powder mass delivered to the spraying station, which however, can give nothing more than a plausibility value.

If it is attempted to continuously monitor effectively the provided coating thickness by sensors located behind the spraying station, considerable difficulties arise in respect to the availability of existing space and the constant contamination by the residual powder not captured by the vacuum removal. A further problem exists in the vibration of the welding arm to which the powder arm with the powder spray station and a coating thickness sensor necessarily has to be applied.

The state of the art for the measurement of the powder coating thickness is described in EP 1 112 801, to which here reference is expressly made. For the solution of the above described problems it is proposed in the mentioned document that the coating thickness of the individual cans be measured by means of a laser beam with the laser source being arranged outside of the seam coating mechanism. With this, each individual can can be tested, which is advantageous in comparison to the previous system of spot-checking. Moreover, the contamination danger concerning the laser source and the associated sensors is considerably reduced.

By means of that proposed method, however, only the input region of each individual can can be tested, and not, however, the interior region. Finally, only small partial areas of the entire coating of the welding seam to be investigated are investigated. Fault spots in the coating remain unrecognized. Moreover, the size of the testing area at the associated ends of the can is dependant on how far the individual cans in the production flow can be spaced from one another, which has the result of requiring a compromise between the expense of the involved apparatus and the testing quality.

The object of the present invention is to provide a method and apparatus through the help of which the quality of the coating applied to a work piece can be continually monitored.

This object is solved by the apparatus according to claim 1.

Accordingly, since the work piece surface with the cover layer is sensed by a plurality of senders and receivers, there results a sensing area of selectable size, which permits an industrial application. Accordingly, since the senders and receivers at the sensor are arranged so as to be mixed with one another there results a uniform sensitivity over the entire sensing region for fault spots in the coating in the way of a facetted eye, which assures a high sensing quality. Also, very thin regions in the coating which no longer completely cover the work piece (as for example, if the work piece surface shines through the coating) are recognized. Fault spots or very thin coating locally create a changed reflectivity of the sensed surface, and the differently reflected measuring beams are conducted through the receivers to the detector and through the computer to create a corresponding measuring signal.

In regard to the given object an embodiment according to claim 2 makes possible a recognition of only small deviations from the desired condition of the coating layer. Accordingly, since the senders and receivers are fixed into position groupwise, and since each group produces its own measuring signal, there also results in the case of small deviations a sufficiently strong deviation in the reflected beams for a reliable evaluation. Problems regarding the processing of weak signals, for example, because of the signal to noise relationship, are avoided.

This groupwise division of the senders and receivers permits the person skilled in the art to put into the apparatus of the invention the necessary requirements taking into consideration the size of the sensing region and also the sensitivity of deviations from the desired condition of the coating layer.

According to claim 5, the apparatus of the invention is integrated in the powder arm of a can welding machine and can reliably and continuously test the thickness of the powder layer over the welding seam along its entire length (the very end regions of the welding seam at the beginning and at the end of the can body are beaded during the rolling of the bottom and the cover of the can and are of minor significance). A fouling of a sensor is hindered or done away with according to claim 11, preferably by means of a directed cleaning air stream.

In the drawings:

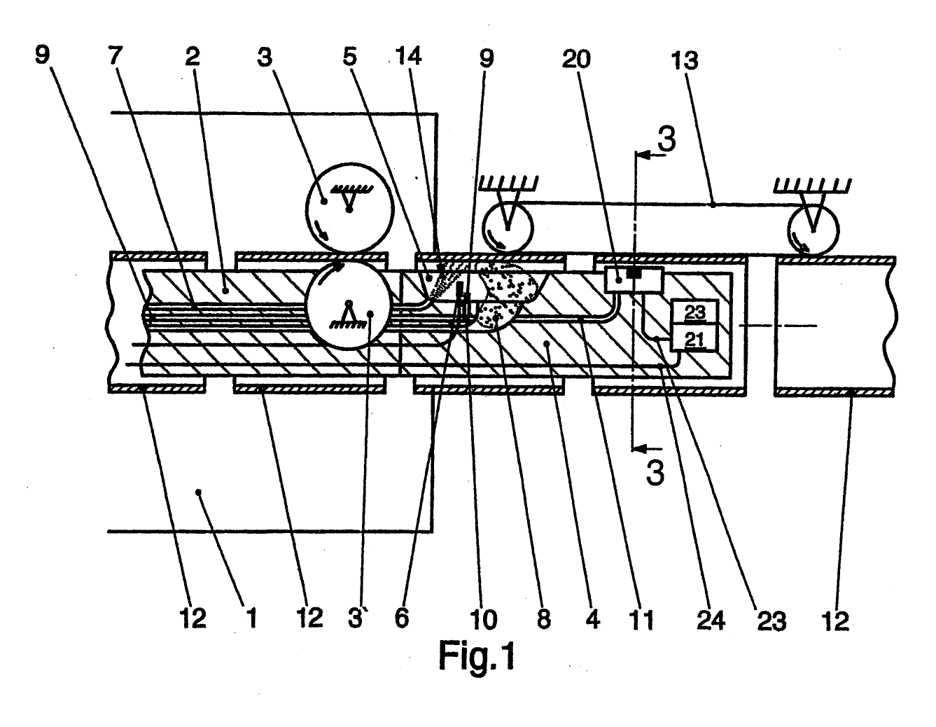

FIG. 1 shows schematically a conventional powder arm installed in a can welding machine, with an apparatus according to the invention,

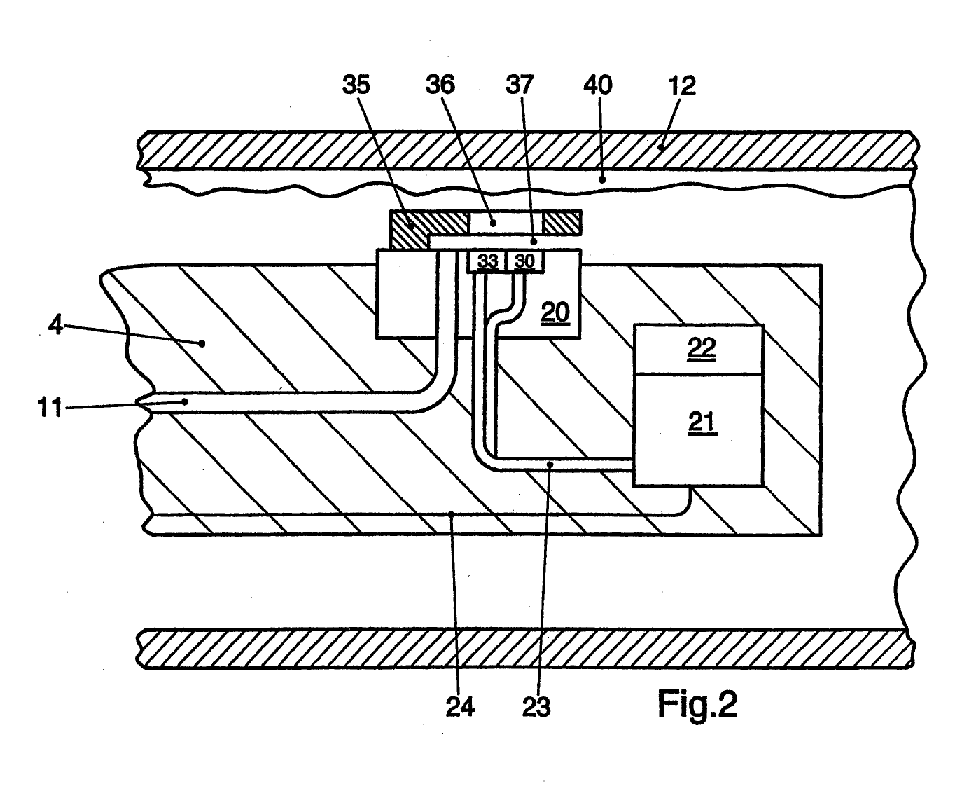

FIG. 2 shows an enlarged section of FIG. 1 with a longitudinal section through the apparatus of the invention,

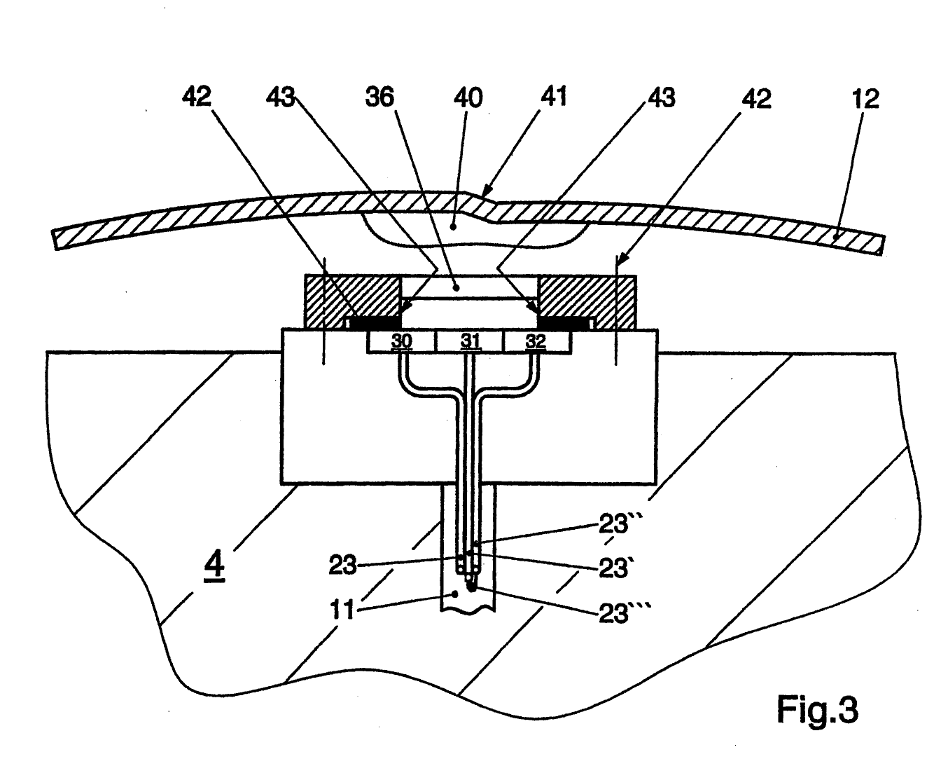

FIG. 3 shows an enlarged cross-section through the apparatus of the invention on the line AA of FIG. 1; and

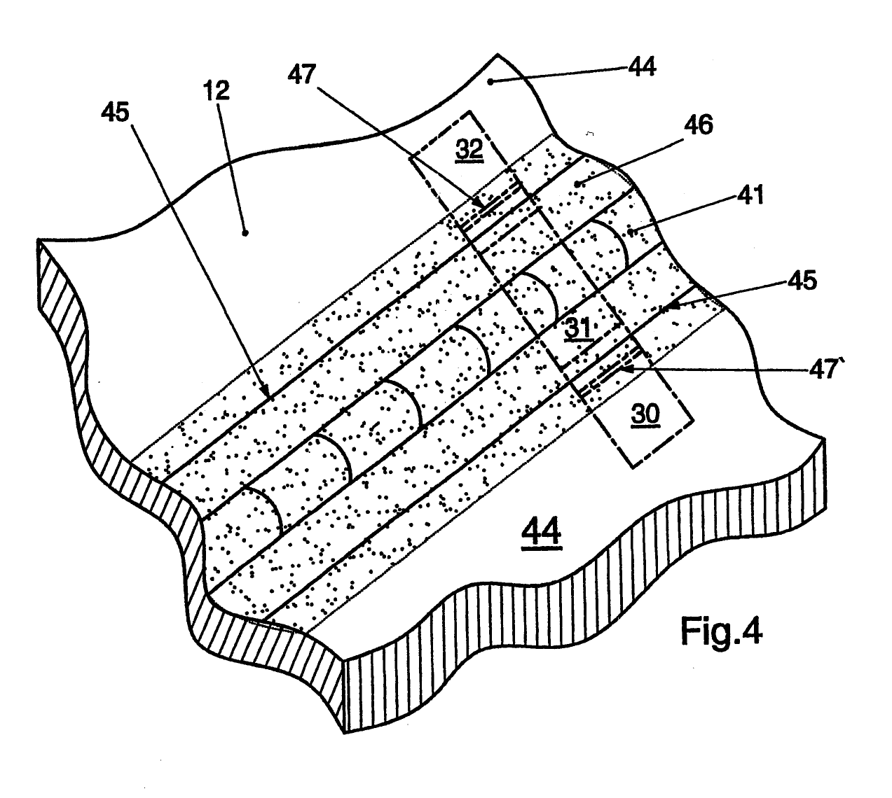

FIG. 4 shows schematically conditions in the region of the welding seam of a can body with a powder coating to be monitored.

FIG. 1 shows a conventional can welding machine 1 with a welding arm 2 and welding rolls 3, 3′. Connected with the welding arm 2 is a powder arm 4 having a powder spray station 5 with an electrode 6 provided therein. A powder duct 7 runs through the welding arm 2 and the powder arm 4 and discharges into a spray space 5. A powder suction removal duct 8 leads out of the spray space 5 and runs back through the powder arm 4 and the welding arm 2. A cleaning air duct 9 likewise runs through the welding arm 2 and the powder arm 4 and discharges in the area of the electrode 6. By way of a branching, this duct continues as a cleaning duct 11 which discharges onto a sensor 20. Further illustrated is a control unit 21 with a computer 22 in the powder arm 4. Quartz fiber conductors 23 connect the sensor 20 and the control unit 21; a data conductor 24 connects the control unit with the control of the welding machine 1, which to simplify the figure is not illustrated, and runs through the powder arm 4 and the welding arm 2. Likewise not illustrated to simplify the figure are current cables for the operation of the control unit 21 by the computer 22. Can bodies 12 move along the welding arm 2 and the powder arm 4. By way of an output belt 13 the can bodies discharged by the welding machine are seized, moved along the powder arm 4 and then delivered to the transport mechanism of an oven connected at the outlet.

To simplify the figure the construction of the control unit 21 with the computer 22 is not illustrated; a person skilled in the art can design this unit in the usual way. In the unit 21, the conductors 23, 23′, 23″, 23′″ of the fiber bundle are preferably separated, so that emitting fibers and receiving fibers are respectively operably associated with the measuring beam source and with a detector for measuring reflected beams. The detectors in turn are operably connected with the computer 22, which is so configured, that it generates a measuring signal from the signals of the detectors, which measuring signals can serve as input signals for the control of the welding machine 1 and for the ejection of faulty can bodies from the transport path.

In operation flat sheet plates are rounded in the welding machine 1 and are then moved along the welding arm 2, where they are welded longitudinally into can bodies by the welding rollers, 3, 3′. In the course of the welding process, at the location of the welding seam, the protective tin coating is removed. During the transport of the bodies along the powder arm 4, at the place of the powder spray station 5, a powder/air stream 14 is blown against the inner side of the body 12, so that the raw welding seam becomes covered by a powder layer. By means of the electrode 6, the powder particles entrained in the powder/air stream 14 become charged, and thereby adhere to the can body. Surplus powder/air mixture is removed from the spray space 5 by the powder suction removal duct 8 and is recycled. By means of the cleaning air duct 9 discharged cleaning air continuously moves around the electrode so that no or only the smallest amount of powder accumulates on the electrode 6. The susceptibility of the electrode 6 to fouling is however high despite the constant air cleaning. The applied powder layer is sensed by the sensor 20 of the invention. In a case of spots lacking powder or having powder layers of insufficient thickness the control unit 21 together with the computer 22 produces a signal which is transmitted over the data conductor 24 to the control of the welding machine 1 (which for simplification is not illustrated in the figure). Thereupon a deflector arranged downstream from the discharge belt 13 is so controlled that cans with insufficient coating are ejected from the transport path leading to the oven.

FIG. 2 shows an enlarged fragment of the forward region of the powder arm 4 with the sensor 20 of the invention, the cleaning air duct 11 and the control unit for the sensor 21. Quartz fiber conductors 23 connect the control unit 21 and the sensor 20. The quartz fiber conductors 23 terminate at the sensor outer surfaces of embedded sensing sections 30, respectively 30, 31, 32 (FIG. 3). The quartz fiber conductor 23′ terminates at a calibrating segment 33. A cover 35 is arranged above the outer surfaces of the sensors 20. As seen, an opening 36 is in the cover, which opening lies above the effective sensor outer surface formed by the segments 30-33 (see also FIG. 3). As further seen, a cleaning channel 37 lies in the cover 35.

Further illustrated in the Figure is a coating layer 40 of sprayed on powder which covers the can sheet, specifically the welding seam.

FIG. 3 shows a cross sectional portion of the powder arm 4 taken on the line AA of FIG. 1. The welding seam 41 is indicated by the thickened spot in the body 12 and is covered by the powder layer 40. The cover 35 is advantageously removably held in place by screws at the places indicated by the broken lines 42. The opening 46 defines the effective area of the sensing segments 30, 31, 32 and is made to be somewhat narrower than the width of the powder layer 40. A sealing element 42 is flush with the wall 43 of the opening 36 and thereby through the opening limits sharply the effective area of the sensor 20 as made up by its sensing segments.

Quartz fiber cables 23, 23′, 23″ convey bundles of quartz fibers which on the side of the sensor lead to the sensing segments 30, 31, 32 and on the side of the control unit 21 are operatively connected with the control unit. Each quartz fiber bundle of each conductor 23, 23′, 23″ on the side of the sensor is so positioned in fanned out manner that the entire rectangular surface of each sensing segment is uniformly occupied with fiber ends.

The calibrating segment 33, not illustrated in the figure, lies behind the segments 30, 31, 32, is covered by these segments, and on the side of the sensor is connected with the quartz fiber cable 23′″. The fiber bundle of the conductor 23′″ is likewise uniformly fanned at the calibrating segment 33 and covers its outer surface with all of its ends facing the body 12. The quartz fiber conductor 23′″ at its other end is connected with the control unit 21.

FIG. 4 shows a portion of the wall of the body 12 at the location of the welding seam 41.

Further illustrated is an interior lacquering 44 of the body 12, such as is usually found in the making of can products. This interior lacquering extends toward the welding seam up to its edge 45, so that the region of the can body to be welded is free of lacquer.

Likewise visible is a powder covered region 46, indicated in the figure by dotted shading which represents a powder strip, as has been applied for covering the raw welding seam.

The Figure further shows, by broken lines 50, the projections of the edges of the segments 30, 31, 32 onto the canned body. The segments are located about six to eight mm perpendicularly over the surface of the body 12. From the Figure, it is seen that the measuring width of the sensing elements 30, 31, 32 exceeds the width of the powder strip 46. With the given configuration, still wider powder strips are detectable depending on the measurements of the opening 36. The opening 36 itself in projection is likewise illustrated by the double lines 47, 47′. Therefore, since the width of the opening 36 (double lines 47, 47′) is chosen to be smaller than the width of the powder strip 46, it is assured that a measurement beyond the edge of the powder covering 46 does not result, and therefore reports of faults at a place where no powder is intended do not occur.

The sensor 20 of the invention cooperates with the control unit 20 as follows:

The control unit has for each of the conductors 23, 23′, 23″ a measuring beam source (or one source which works on all of the conductors). The measuring beams are conducted through the fiber bundles respectively associated with the segments, 30, 31, 32 and at each segment are emitted from the fiber ends. Because of the uniform distribution of the fiber ends at each sensing segment (30, 31, 32), there results a uniform illumination of the powder layer 40.

The measuring beams are scattered at the grainy surface of the powder layer 40 and are reflected back to the region of the sensing elements only to a small degree. Now, further quartz fibers are engaged with the sensing segments 30, 31, 32, which fibers are likewise bundled in the conductors 23, 23′, 23″ and led to the control unit 21. By way of these further fibers, the reflected measuring beams in the segments 30, 31, 32 can be received and for each segment transmitted to a detector for each of the conductors 23, 23′, 23″.

The reflection of the measuring beams changes in relation to the thickness of the powder layer 40. If the powder layer contains holes the reflection is maximal. These reflected beams create in each associated detector of the control unit 22 a signal, which is processed by the computer 22. If a given threshold set into the computer 22 is exceeded the computer generates a reject signal which is conducted through the data conductor 24 to the control of the welding machine 1 and causes the ejection of the can with the faulty layer.

Each fiber which emits the measuring beam corresponds to a sender of the measuring beam, and each fiber which can receive the reflected measuring beam is a receiver for the reflected measuring beam. The uniform distribution of the senders creates a uniform illumination of the surface to be sensed. It is now important that the receivers are arranged uniformly over the surface of the sensing elements. As a result, the sending and receiving fibers are uniformly mixed with one another in the sensing segment arrangement. The sensing elements are, therefore, sensitive with uniform sensing quality to the changed reflection of the measuring beams, due to fault spots in the powder layer 46, over the entire sensing width defined by the opening 36.

The reflected measuring beams are correspondingly detected over the entirety of each sensing segment 30, 31, 32 and are as total intensity per segment transmitted to the associated detector in the control unit. It follows that in the case of a wide sensing segment, a small fault spot leads to a comparatively small intensity change in the reflected measuring beam, while on the other hand in the case of a small sensing segment the same fault spot leads to a larger change in the reflected measuring beam. It is then desirable that the intensity change of the reflected measuring beam is not allowed to fall below a lower threshold value, so that the detectors of the control unit 21 and the associated computer 22 receive easily processable signals which, for example, have a sufficiently large margin from signal noise. In keeping with the invention, a person skilled in the art, proceeding from the size of still to be recognized fault spots and the ability of the control unit 21 to distinguish intensity signals, can determine the maximum measurements of the sensing segments or also, for given segments, can determine the minimum size of fault spots capable of being recognized.

Comparatively FIG. 3 shows sensing segments of 6 mm length, which are suitable for a measuring area having a width of about 12 mm. Therefore in this case, fault spots of about 8.0 mm diameter can be reliably recognized.

Preferably, the fibers have small diameters from 20 μm to 200 μm, and especially suitable is a diameter of 50 μm.

For the measuring beams, preferably infrared light is used which is independent of daylight and therefore independent of the production environment. However, other measuring beams can also be used according to the character of the covering layer and the underlying work piece surface. Most relevant to the choice of the type of measuring beam is the difference in the reflection properties of the coating layer and of the work piece surface. In the case of measuring beams other than infrared beams, a person skilled in the art can determine an optimum beam conducting fiber. Quartz fibers are especially suitable for the infrared region.

If the powder covering of a can seam is to be inspected, the reflectability of the welded seam can be improved (and thereby its contrast to the scattered powder layer increased), by having the welding process carried out during the delivery of a protective gas.

FIG. 2 shows a calibrating segment 33 which through the conductor 23′″ is preferably supplied with white light from the control unit 21. If the seam coating system is to be set into operation for the production, the operator can activate the calibrating segment and can recognize from its illumination the sensing region on the can. Thereafter, using a test can having a fault free coating, the reflectability of the measuring beams can be determined and from this the necessary threshold values can be input into the computer 22.

The arrangement of FIG. 3 shows three sensing segments arranged in line and next to one another. However, any desired number of such segments can be connected next to one another so as to lead to any desired width of the sensing region. In this way, even the entire circumference of the can can be sensed by the segments, which for example, makes it possible to test the coating in the case of an entire spraying.

Likewise in a further embodiment it can be provided that the segments are arranged so as to be displaced from one another in the feed direction, which simplifies the mechanical construction of the inspection apparatus.

1. An apparatus for the continuous measurement of the thickness of a coating layer of a workpiece moved relative to the apparatus, characterized by a sensor with a plurality of senders of measuring beams and a plurality of receivers for measuring beams reflected from the coating layer and/or from the work piece. The senders and the receivers at the sensor are arranged in intermixed condition with one another. A computer generates a continuous measuring signal in dependence on the two parameters of the emitted and received measuring beams.

2. An apparatus according to claim 1 further characterized in that the senders and receivers lying next to one another and collectively positioned in groupwise fashion. Each group has associated with it its own source of measuring beams and has associated with it its own detector for the beams reaching the receivers. Each group has associated with it its own computer for forming a measuring signal.

3. An apparatus according to claim 1, further characterized in that the senders are connected with the beam source and/or the receivers are connected with the detector by way of beam conducting fibers, preferably quartz fibers.

4. An apparatus according to claim 1 further characterized in that the sensor includes means for removing and for keeping removed contaminations from the sensitive outer surface of the sensor.

5. An apparatus integratable into a powder arm for the measurement of the thickness of a powder layer for the coating of can sheet material according to claim 2, further characterized in that the senders and the receivers are arranged in a sensor head and are connected by beam conducting fibers, preferably quartz fibers, with the associated beam source and the associated detector, that at the sensor head an exchangeable cover is provided for limiting the measuring width of the sensor, which includes cleaning means for protecting the effective sensor surface, and in that the associated beam source and the associated detector are operably connected with a computer for generating a measuring signal.

6. An apparatus according to claim 5, further characterized in that the beam source creates infrared beams.

7. An apparatus according to claim 5, further characterized in that the cleaning means has a cleaning channel running over the effective sensor surface and whose cover is penetrated in the region of the senders and receivers.

8. An apparatus according to claim 5, further characterized in that the beam conducting fibers have a diameter of 20 to 200 μm, preferably 50 μm.

9. An apparatus according to claim 5, further characterized in that the sensor head has three groups of senders and receivers, which groups are arranged in a line.

10. An apparatus according to claim 5, further characterized in that the sensor head has a fourth group with only senders and which by means of beam conducting fibers is connected with a source of light, preferably white light.

11. A seam covering arrangement with an apparatus according to claim 1.

12. A can welding machine with a seam covering arrangement with an apparatus according to claim 1.
